(19) United States
(12) Patent Application Publication
(10) Pub. No.: US 2011/0097576 A1
(43) Pub. Date: Apr. 28, 2011

(54) RE-PEELABLE ADHESIVE SHEET

(75) Inventors: Takashi HABU, Ibaraki-shi (JP); Fumiteru ASAI, Ibaraki-shi (JP); Toshio SHINTANI, Ibaraki-shi (JP); Takatoshi SASAKI, Ibaraki-shi (JP); Kouji MIZUNO, Ibaraki-shi (JP)

(73) Assignee: NITTO DENKO CORPORATION, Osaka (JP)

(21) Appl. No.: 12/908,626

(22) Filed: Oct. 20, 2010

(30) Foreign Application Priority Data
Oct. 23, 2009 (JP) JP2009-244032

(51) Int. Cl. B32B 33/00; B32B 15/082; B32B 5/00

(52) U.S. Cl. 428/336; 428/343; 428/355 AC

(57) ABSTRACT

A re-peelable adhesive sheet for grinding a semiconductor wafer comprises: a base film, and an adhesive layer laminated on the base film, the re-peelable adhesive sheet has a modulus of elasticity of at least 10³ MPa, and a heating shrinkage factor of 1% or less, after heating for 10 minutes to 60° C., and the adhesive layer is set to a thickness at which the maximum point stress is 200 g/cm or less, at a pressing amount of 30 μm from the adhesive layer side in a three-point bend test. The present invention can provide a re-peelable adhesive sheet that can reduce wafer warping, cracking, and edge chipping, that can improve the adhesive force in relation to temperature variations and/or reduce contamination of the adherend when re-peeling, and that can facilitate film re-peel.

### BACKGROUND OF THE INVENTION

1. Field of the Invention

The present invention relates to a re-peelable adhesive sheet, and more particularly relates to a re-peelable adhesive sheet that is used in a semiconductor manufacturing process.

2. Background Information

In recent years, there has been a need for a reduction in the thickness of semiconductor wafers to the level of 50 μm or less due to the downsizing of various types of electronic components and the widespread application of IC cards. Further increases to the wafer diameter are under consideration in order to improve productivity.

Normally, during manufacture of a semiconductor wafer, the back surface of the wafer is adjusted to a predetermined thickness by grinding (machining) with a grinder or the like after forming a circuit pattern on the wafer top surface. Generally, the wafer top surface is protected during this process by application of an adhesive sheet to the wafer top surface, and then executing back grinding. After grinding of the wafer, the wafer may be conveyed to the next processing step with the adhesive sheet attached to the wafer top surface.

However a wafer after back grinding tends to undergo warping. The problem of warping is particularly severe in general purpose large wafers having a diameter of 8 inches or 12 inches, or thin wafer for use in relation to IC cards. Furthermore wafers that have undergone warping tend to crack during conveying or when removing the adhesive sheet.

Generally warping of wafers when an adhesive sheet has been applied directly after completion of grinding is greater than in a wafer after re-peeling the adhesive sheet. In other words, it is thought that when a wafer with an adhesive sheet attached is ground to an extremely low thickness, the residual stress of the adhesive sheet is greater than the strength of the wafer, and therefore warping is the result of the force of the wafer to cancel out this residual stress.

In this context, reducing the residual stress has been proposed by use of a base film configuring the adhesive sheet that has a Young's modulus (tensile elastic modulus) of at least 0.6 GPa (for example, JP 2000-212524-A).

Furthermore an adhesive sheet has been proposed that demonstrates a stress relaxation rate after one minute to a 10% elongation percentage of at least 40% during tensile testing (for example, JP 3383227-B)).

However when a semiconductor wafer is ground to an extremely low thickness, or when a large diameter wafer is ground, the overall characteristics of these adhesive sheets are not always optimal for suppressing wafer warping after grinding.

Furthermore the development towards increasingly low wafer thickness in recent years has caused wafer cracking due to stress during machining/grinding, or a tendency for chipping of the wafer edge portion.

For that reason, an adhesive sheet has been proposed with a low adhesive force that does not damage the semiconductor wafer during grinding processing or pick-up after dicing, and that facilitates re-peel (for example, JP 3862489-B).

This adhesive sheet has an adhesive force that facilitates re-peel, prevents entry of grinding water during grinding processes, that maintains a required adhesive force, and in addition that suppresses adhesive residue on the top and back surfaces of the wafer after removal of the adhesive sheet.

Techniques have been developed in recent years that stack chips in order to realize high-density, downsized and high-functional semiconductor packages. However problems have arisen with respect to deviations in thickness between the chips of extremely thin wafers. Deviations in thickness between chips mean that thickness deviations of the adhesive sheet that protects the pattern during wafer grinding are transferred without modification after grinding, and therefore serious problems are caused in relation to the accuracy of the thickness of the adhesive sheet.

To improve the handling characteristics of extremely thin wafers, equipment manufacturers have adopted techniques that enable inline completion from the wafer grinding process to the process of mounting on the dicing tape, and then removal of the adhesive tape from the wafer surface. In other words, a technique using a 2-in-1 DAF configuration has been adopted which integrates the dicing tape and the die attach film (DAF). Since this method includes heating to substantially 100° C. for example when mounting and processing the wafer on the 2-in-1 DAF, it is desirable to avoid an increase in the adhesive force after heating in view of preventing warping in the wafer due to contraction of the adhesive sheet after heating and removal of the adhesive sheet thereafter.

The adhesive sheet that has currently attracted the most attention is a radiation-curable adhesive sheet. However when the adhesive layer is cured using irradiation, a strong odor is produced and there is an adverse effect on the health and hygiene of operational personnel. Furthermore although non-contamination characteristics of the wafer after removal are relatively good, the trend towards downsizing of semiconductor packages means that contamination caused by adhesive residue on the adhesive layer must be minimized on the micron order or sub-micron order to thereby maintain long-term reliability of semiconductor integrated circuits.

### SUMMARY OF THE INVENTION

The present invention is proposed in light of the above problems, and has the object of providing a re-peelable adhesive sheet that reduces wafer warping, cracking, and edge chipping, that improves the adhesive force in relation to temperature variations and/ or reduces contamination of the adherend when removing, and that facilitates film re-peel.

The present invention provides a re-peelable adhesive sheet for grinding a semiconductor wafer comprising:
a base film, and
an adhesive layer laminated on the base film,
the re-peelable adhesive sheet has a modulus of elasticity of at least 10³ MPa, and a heating shrinkage factor of 1% or less after heating to 60° C. for 10 minutes, and
the adhesive layer has a thickness at which the maximum point stress is 200 g/cm or less, at a pressing amount of 30 μm from the adhesive layer side in a three-point bend test of the re-peelable adhesive sheet.

According to the present invention, it is possible to provide a re-peelable adhesive sheet that can reduce wafer warping, cracking, and edge chipping, that can improve the adhesive force in relation to temperature variations and/or reduce contamination of the adherend when re-peeling, and that can facilitate film re-peel.

### DETAILED DESCRIPTION OF THE PREFERRED EMBODIMENTS

The re-peelable adhesive sheet according to the present invention (hereinafter referred to simply as “adhesive sheet”) is mainly composed by a base film and an adhesive layer.

The re-peelable adhesive sheet according to the present invention is a releasable product used in semiconductor device manufacturing. It can be used as a fixing adhesive sheet for semiconductor wafer or the like, or as a protective/masking adhesive sheet for a semiconductor or the like. For example, this adhesive sheet can be utilized as a adhesive sheet for the back-grinding of a silicon semiconductor, a adhesive sheet for the back-grinding of a compound semiconductor, a adhesive sheet for dicing of a silicon semiconductor, a adhesive sheet for dicing of a compound semiconductor, a adhesive sheet for dicing of a semiconductor package, a adhesive sheet for dicing of glass, a adhesive sheet for dicing of a ceramics, a adhesive sheet for protecting of a semiconductor circuit and the like. In particular, this sheet can be affixed to one side of the semiconductor wafer when a semiconductor wafer rear face is polished, for example, when the semiconductor wafer is being ground extremely thin and/or when a large-diameter wafer is being ground, etc.

This sheet can be used in a wide range of applications such as;

removal (re-peel) of debris in the manufacture and grinding of various products and parts that entail the peeling away of a surface protective sheet, and in various kinds of manufacturing apparatus;

surface protection against corrosion (rust), shavings and the like produced by cutting water during dicing and the like;

masking and so forth, either during the use of this adhesive sheet for dicing a semiconductor wafer or at the end of its use.

Even when grinding a semiconductor wafer to an extremely low thickness and/or when grinding a large diameter wafer, use of the re-peelable adhesive sheet according to the present invention in this manner avoids production of warping of the wafer due to the rigidity of the base film composing the adhesive sheet, and therefore enables superior stress dispersion characteristics during grinding. Furthermore cracking of the wafer and chipping of the wafer edge are effectively suppressed. In addition, thickness accuracy after grinding can be improved. Even when using a 2-in-1 DAF configuration, an increase in the adhesive force of the adhesive during heat-curing steps can be suppressed. When re-peeling the film after processing, re-peel is facilitated without soiling of the adherend.

Any material having rigid properties may be used as the base film. A modulus of elasticity is an example of a standard for rigidity.

The re-peelable adhesive sheet according to the present invention has a modulus of elasticity in the adhesive sheet itself of at least 10³ MPa, more preferably at least 2000 MPa, still more preferably at least 3000 MPa to less than or equal to 10000 MPa. Furthermore, after heating to 60° C. for 10 minutes, the adhesive sheet has a heating shrinkage factor of 1% or less, more preferably 0.5% or less, and still more preferably 0.2% or less. The presence of these characteristics enables the useful effects described above.

Consequently it is preferred that the base film has the following modulus of elasticity and heating shrinkage factor in order to ensure the characteristics described above in the adhesive sheet itself.

The modulus of elasticity for example is suitably at least 1000 MPa, preferably at least 2000 MPa, and more preferably at least 3000 MPa to less than or equal to 10000 MPa. This range suppresses warping and enables stable re-peel.

The modulus of elasticity can be normally expressed as a value measured using a method of calculating an initial modulus of elasticity as described in the Examples.

When heat processing the DAF after grinding is considered, a small heating shrinkage factor, in other words, non-shrinkage is preferred. More specifically, a value of 1% or less after heating for 10 minutes to 60° C. is suitable. More preferably, the value is about 0.5% or less, or still more preferably is about 0.2% or less. This range enables suppression of warping in the wafer after heat processing even during DAF attachment, and enables re-peel of the adhesive sheet without applying a stress to the wafer. The heating shrinkage factor is normally expressed as a value measured using a method as described in the Examples.

Examples of the base film include a film or a sheet made of one or more resin selected from a group comprising polyesther resins such as polyethylene terephthalate, polybutylene terephthalate, polyethylene naphthalate; polyolefin resions such as polyethylene, polypropylene; polyimide resins; polyamide resins; polyurethane resins; styrene resins such as polystyrene; polyvinylidene chloride; polyvinylchloride; and the like. Among these, a film or a sheet made of polyesther resins, polyimide resins or the like is preferable from the point of view of excel in application workability of the adhesive described below. The base film can be formed as a single layer or as a multilayer of more than two layers.

When the adhesive layer discussed below is a radiation (energy) curing type of adhesive, the base film is preferably one that can transmit at least a specific amount of radiation (such as a resin that is transparent) so that the radiation can be applied through the base film.

One or both sides of the base film may have undergone corona treatment or other such physical or chemical surface treatment.

The film thickness of the base film can be suitably adjusted to a range that does not adversely affect handling characteristics. For example, adjustment is preferred to a level of about 50 to 300 μm, and about 70 to 200 μm is more preferred. This range enables adjustment of the rigidity of the base film to a suitable level, and when combined with the characteristics of the adhesive layer as described below, enables suitable stress dispersion characteristics during grinding.

The adhesive layer in the adhesive sheet according to the present invention is suitably a re-peelable adhesive layer that includes adhesive characteristics enabling adhesion to the adherend, and that can reduce or eliminate the adhesive characteristics, after completion of a predetermined role, with a certain type of method (for example, tackiness reduction processing).

This type of re-peelable adhesive layer can have the same configuration as an adhesive layer of a known re-peelable adhesive sheet.

For example, the adhesive layer including an acrylic polymer is suitable. “Including” as used herein means use as a base polymer for an adhesive at least about 50 wt% of the total adhesive weight, preferably at least about 60 wt%, and still more preferably at least about 70 wt%.

Examples of a monomer used as a starting material of the acrylic polymer include an alkyl ester of (meth)acrylic acid such as methyl (meth)acrylate, ethyl (meth)acrylate, propyl (meth)acrylate, butyl (meth)acrylate, 2-ethylhexyl (meth)acrylate, octyl (meth)acrylate, i.e., a C₁ to C₁₈ alkyl (meth)acrylate.

Examples of the acrylic polymer include a homo-polymer or a copolymer of the above monomers; a copolymer of the above monomer such as an alkyl ester of (meth)acrylic acid and another copolymerizable monomer.

The monomer can be used alone or as mixture of two or more monomers.

Examples of such another copolymerizable monomer include, for example,

a carboxyl or acid anhydride group-containing monomer such as (meth)acrylic acid, crotonic acid, itaconic acid, fumaric acid, maleic acid, maleic anhydride and itaconic anhydride;

a hydroxyl-containing monomer such as 2-hydroxyethyl (meth)acrylate;

an amino group-containing monomer such as (meth)acryloyl morpholine;

an amide group-containing monomer such as (meth)acrylamide.

Among these, (meth)acrylic acid is preferable, and acrylic acid is more preferable. Such monomer is preferable since the monomer can introduce crosslink bond into polymer.

Examples of such another monomer may further include;

a vinyl esther such as vinyl acetate;

a stylene monomer such as stylene;

a cyano group-containing monomer such as acrylonitrile;

a cyclic or non-cyclic (meth)acrylic amide; and

a variety of other such monomers known as a monomer for the modification of the acrylic pressure sensitive adhesives.

The amount of the other copolymerizable monomers is preferable about 50 wt% or less of all of the monomers containing the acrylic monomer.

In particular, an acrylic polymer is preferably obtained by copolymerizing 90 wt% or more of butyl acrylate with 5 wt% or less of acrylic acid monomer.

The polymerization reaction for obtaining the acrylic polymer can be performed using with an initiator which generates radicals by its decomposition. An initiator generally used for radical polymerization can be utilized for this reaction.

An organic peroxide such as dibenzoyl peroxide, di-t-butyl peroxide, cumene hydroperoxide, and lauryl peroxide; azo compound such as 2,2′-azobisisobutyronitrile and azobisisovaleronitrile may be used as such initiator, when the polymerization reaction is performed at a temperature of about 40 to 100° C.

Also, a redox initiator such as dibenzoyl peroxide and dimethylaniline can be used as such initiator, when the polymerization reaction is performed at a temperature of about 20 to 40° C.

The amount of the initiator may be an amount normally used when polymerizing an acrylic monomer. For example, about 0.005 to 10 parts by weight with respect to 100 parts by weight of the monomer is suitable, and about 0.1 to 5 parts by weight is preferred.

The adhesive layer configuring the adhesive sheet according to the present invention suitably has a predetermined molecular weight components (low molecular weight components) having an average molecular weight of 10⁵ or less of 10 wt% or less relative to the total base polymer configuring the adhesive. In particular, the content of low molecular weight components relative to an acrylic polymer in the base polymer of the adhesive is suitably 10 wt% or less. In this manner, the cohesive force and adhesive force are improved by reducing the low molecule weight components in the base polymer of the adhesive, in particular, contamination of the adherend is conspicuously reduced. The content ratio of molecular components of 10⁵ or less in the polymer and the average molecular weight of the polymer can be calculated using a method of gel permeation chromatography (GPC method).

In other words, contaminants during re-peel of the adhesive sheet, that is to say, the transfer amount of organic substances, can be reduced by use of an acrylic polymer having a content of low molecular components of 10 wt% or less. For example, when the adhesive sheet is attached to an aluminum vapor deposition wafer, left for one day at 40° C., and then re-peeled, less than or equal to about 14.05 atomic% can be present on the wafer, preferably less than or equal to about 13 atomic%, and more preferably less than or equal to about 12.8 atomic%.

In another aspect, irrespective of whether or not an acrylic polymer with restricted low molecular weight content as described above is used (preferably, an acrylic polymer with 10 wt% or less of low molecular weight content), the adhesive force of the resulting adhesive sheet is suitably of the level of about 1.0 N/20 mm or less, preferably of the level of about 0.8 N/20 mm or less, and more preferably of the level of about 0.6 N/20 mm or less, at 40° C. relative on a Si wafer or PI (polyimide) coated wafer. The top layer of a wafer having a pattern formed thereon is often coated with PI as an insulating film for protection, and this configuration also requires enablement of stable re-peel. An adhesive force in this range enables stable re-peel even from an extremely thin ground wafer in a manufacturing step.

This type of polymer for example uses liquid carbon dioxide or supercritical carbon dioxide as a diluent, and is obtained by polymerization of monomers in the diluent.

The amount of carbon dioxide used as a diluent is for example suitably about 5 to 2000 parts by weight, and preferably about 20 to 900 parts by weight of 100 parts by weight of the total monomer component.

Polymerization is performed in carbon dioxide regulated to a pressure of substantially about 5.73 to 40 MPa, for example at a temperature of 20 to 100° C., normally for 1 to 30 hours, and preferably for about 10 hours. The temperature and pressure for polymerization may be varied into a plurality of stages as required.

When carbon dioxide is used as a diluent, during polymerization from beginning to end, the elongating polymer can be maintained to a low viscosity as a result of the diluent effect, and therefore stirring is efficient. Furthermore since radical chain transfer does not occur, the low molecular component is low in comparison with a polymer synthesized using conventional organic solvents, and a high molecular weight polymer can be obtained.

Carbon dioxide is normally sufficient as the diluent. However as required, a small amount of an organic solvent can be added to improve mixing characteristics.

The polymer having a content of low molecular weight components of 10 wt% or less can be obtained by solution polymerization of monomers in a diluent such as an organic solvent including toluene, ethyl acetate or the like by suitable setting of polymerization conditions including the type or the amount of initiator, the polymerization temperature, the polymerization time, and the like in response to the type of monomer. Solution polymerization for example can be performed in a reaction vessel including a cooling tube, a nitrogen introduction tube, a thermometer, a stirring apparatus, and the like. The amount of the organic solvent that is used is suitably about 5 to 2000 parts by weight, and preferably about 20 to 900 parts by weight, for example of 100 parts by weight of the total monomer component.

The polymer with a low molecular weight component content of 10 wt% or less can be obtained by emulsion polymerization of monomers in an aqueous dispersal system. There is no particular limitation on the method used in relation to emulsion polymerization. A method may be used according to the purpose or use and includes a method of polymerizing by loading an emulsion dispersion of a monomer mixture into water, a dripping method, or the like.

There is no particular limitation on the emulsifier used in the emulsion polymerization and for example, the emulsifier includes a non-ionic surface active agent and/or an anionic surface active agent. The emulsifier may be used singly or in combination of two or more emulsifiers.

Examples of the non-ionic surface active agent include polyoxyethylene alkylether, polyoxyethylene alkylphenylether, polyoxyethylene-polyoxypropylene block copolymer, sorbitan fatty acid ester, polyoxyethylene fatty acid ester and the like.

Examples of the anionic surface active agent include alkyl sulfate, alkyl benzene sulfonate, alkyl sulfosuccinate, polyoxyethylene alkyl sulfate, polyoxyethylene alkyl phosphate and the like.

The amount of emulsifier used may be suitably adjusted in response to the required particle system. For example when a non-ionic surface active agent or an anionic surface active agent is used singly, generally about 0.3 to 30 parts by weight relative to 100 parts by weight of the total monomer is suitable. When a non-ionic surface active agent and an anionic surface active agent are used in combination, generally about 0.2 to 20 parts by weight of the former and about 0.1 to 10 parts by weight of the latter relative to 100 parts by weight of the total monomer are suitable.

The polymer that is polymerized using the method described above may be used without modification as the base polymer in the adhesive. However normally it is suitable to include a cross linking agent for the purpose of improving the cohesive force of the adhesive.

A polyfunctional (meth)acrylate and the like can be added as an internal cross-linking agent at the polymerization of the acrylic polymer, or a polyfunctional epoxy compound, an isocyanate compound and the like can be added as an external cross-linking agent after the polymerization of the acrylic polymer in order to obtain a cross-linked acrylic adhesive. A cross-linking treatment may be performed by radiation. Among these, the external cross-linking agent such as a polyfunctional epoxy compound and a polyfunctional isocyanate compound is preferably added to the adhesive. The term “polyfunctional” here means to have two or more functional groups.

Examples of the polyfunctional epoxy compound include various compounds having 2 epoxy groups therein, for example, sorbitol tetraglycidyl ether, trimethylolpropane glycidyl ether, tetraglycidyl-1,3-bisaminomethylcyclohexane, tetraglycidyl-m-xylenediamine, triglycidyl-p-aminophenol and the like.

Examples of the polyfunctional isocyanate compound include, for example, diphenyl methandiisosianate, tolylene diisocyanate, hexamethylene diisocyanate and the like.

These cross-linking agents can be used alone or as mixture of more than two compounds. The amount used can be suitably adjusted according to the composition or molecular weight of the acrylic polymer and other such factors. To promote the reaction here, dibutyltin laurate or another such cross-linking catalyst that is normally used in adhesives may be used.

The thickness of the adhesive layer can be suitable adjusted to the type of adhesive used. The thickness is suitably set to a thickness at which the maximum point stress is about 200 g/cm or less, preferably about 180 g/cm or less, and more preferably about 160 g/cm or less, at a pressing amount of 30 μm from the adhesive layer side in a three-point bend test on an adhesive sheet forming an adhesive layer on a base film. In particular, the thickness of the adhesive layer is generally about 40 μm or more, and preferably about 40 to 60 μm when the above base film is used for the adhesive sheet.

The adhesive sheet of the present invention may comprise at least one above-mentioned adhesive layer on one side of the base film or a plurality of the above-mentioned adhesive layers on both sides of the base film, and may comprise a single adhesive layer or laminated adhesive layers or the like.

Also, it is preferable if a removable film is provided over the adhesive layer until the time of use so as to protect the adhesive layer.

There are no particular restrictions on the form of the adhesive sheet, which may be in the form of a sheet, a tape or the like.

In the manufacture of the adhesive sheet of the present invention, the adhesive layer may be formed as a thin film by discharging the adhesive through a die or the like under the condition of high pressure containing carbon dioxide to atmospheric pressure. Also, the adhesive layer may be formed as a thin film by re-dissolving a collected polymer after reducing the high pressure to the atmospheric pressure in an organic solvent (for example, toluene, ethyl acetate or the like) as needed, and applying it directly over the base film by a known coating method such as a roll coater. Another method that can be used is to form the adhesive layer by coating a suitable removable liner (separator), and transferring this over to the base film. When the layer is formed by the transfer, any voids generated at the interface between the base film and the adhesive layer can be expanded and popped or diffused by performing a heating and pressurizing treatment, such as in an autoclave, after the transfer to the base film.

Also, when a polymer is manufactured by solution polymerization, emulsion polymerization or the like, the adhesive layer can be formed by coating the base film or separator or the like by a known method with the resulting polymer solution or polymer aqueous dispersion.

The adhesive layer formed in this manner may, if needed, be cross-linked in a drying step or in a subsequent light irradiation step, electron beam irradiation step, or the like.

The adhesive sheet according to the present invention minimizes warping of the wafer after semiconductor wafer grinding by suitable combination of the above base film, adhesive layer, and the like. For example, although there are dimension dependent effects, the effect in an 8-inch or 12-inch wafer can be reduced to about 10 mm or less, or furthermore to about 8 mm or less.

Furthermore the total thickness variation (TTV) between the upper and lower limiting value of the inner face thickness of the semiconductor wafer can be suppressed to a minimum. For example, although there are dimension dependent effects, the effect in an 8-inch or 12-inch wafer can be reduced to about 6.0 μm or less, about 5.8 μm or less, about 5.5 μm or less, about 5.4 μm or less, about 5.2 μm or less, or about 5 μm or less.

An Examples of the re-peelable adhesive sheet according to the present invention will be described in detail hereafter.

In the absence of an express indication to the contrary in the Examples and Comparative Examples, parts and % refers to parts by weight.

### Example 1

100 parts of n-butyl acrylate, 3 parts of acrylic acid, and 0.1 parts of 2,2′-azobisisobutyronitrile were combined at 25° C. to make a total of 200 g in a 500 ml flask. The contents were stirred while introducing nitrogen gas into the flask for approximately one hour to replace the contained air by nitrogen. Thereafter the flask was heated to increase the internal temperature to 60° C., polymerization was executed by maintaining this state for six hours to thereby obtain a polymer solution.

To 100 g of this obtained solution were added 2 g of polyisocyanate compound (trade name “Coronate L,” made by Nippon Polyurethane Industry), 0.5 g of polyfunctional epoxy compound (trade name “tetrad C,” made by Mitsubishi gas chemical company, Inc.), diluted with ethyl acetate, and stirred to combine to prepare an adhesive solution.

A re-peelable adhesive sheet was prepared by coating the resulting adhesive solution onto a polyester film (PET, thickness 50 μm) acting as a base film, and drying in a drying oven for three minutes respectively at 70° C. and 130° C. to thereby form an adhesive layer having a thickness of 50 μm.

### Example 2

An adhesive sheet was manufactured in the same manner as the Example 1 with the exception that a polyimide film (PI, thickness 50 μm) was used as a base film in substitution for a polyester film.

### Example 3

An adhesive sheet was manufactured in the same manner as the Example 1 with the exception that a polyethylene naphthalate film (PEN, thickness 50 μm) was used as a base film in substitution for a polyester film.

### Comparative Example 1

An adhesive sheet was manufactured in the same manner as the Example 1 with the exception that the adhesive layer having the thickness of 50 μm was changed to the thickness of 20 μm.

### Comparative Example 2

An adhesive sheet was manufactured in the same manner as the Example 1 with the exception that an ethylene-vinyl acetate copolymer film (EVA, thickness 115 μm) was used as a base film in substitution for a polyester film, and the adhesive layer having the thickness of 50 μm was changed to the thickness of 40 μm.

### Comparative Example 3

77 parts of 2-etylhexyl acrylate, 20 parts of acryloylmorpholine, 3 parts of acrylic acid and 0.2 parts of 2,2′-azobisisobutyronitrile were combined at 25° C. to make a total of 200 g in a 500 ml flask. The mixture was stirred with a stirring blade while introducing high-purity carbon dioxide gas into the flask, and maintained under pressure of 2 MPa. After several seconds, carbon dioxide was discharged from an exhaust port, and replaced the contained residual air by carbon dioxide. Thereafter, high-purity carbon dioxide gas was again introduced into the flask at 25° C. in the same manner with the above, and maintained under pressure of 7 MPa. And then, the flask was heated to increase the internal temperature to 60° C., at this stage, high-purity carbon dioxide gas was again introduced into the flask to adjusting the internal pressure to 20 MPa. The polymerization was executed by maintaining this state for 12 hours, and the internal pressure reduced to ambient pressure to thereby obtain a polymer solution.

To 100 g of this obtained solution were added 1.5 g of polyisocyanate compound (trade name “Coronate L,” made by Nippon Polyurethane Industry), 2 g of polyfunctional epoxy compound (trade name “tetrad C,” made by Mitsubishi gas chemical company, Inc.), diluted with ethyl acetate, and stirred to combine to prepare an adhesive solution.

A re-peelable adhesive sheet was prepared by coating the resulting adhesive solution onto a polyester film (PET, thickness 50 μm) acting as a base film, and drying in a drying oven for three minutes respectively at 70° C. and 130° C. to thereby form an adhesive layer having a thickness of 35 μm.

Evaluation Testing

The adhesive sheets obtained in the Examples and the Comparative Examples were tested and evaluated using the following methods. The results are shown in Table 1.

Initial Modulus of Elasticity

A stress-strain (S-S) curve was prepared by tensioning a strip of adhesive sheet having a width of 5 mm at 23° C. between chucks for 50 mm at a speed of 30 mm/minute. The initial modulus of elasticity is the value obtained from the S-S curve. A triple-sample tensile testing apparatus AG-IS (Shimadzu Corporation) was used in as a tensile testing apparatus.

Heating Shrinkage Factor

An adhesive sheet was cut into 10 cm×10 cm and the dimensional change before heating and after heating to 60° C. for 10 minutes was measured using a PROFILE PROJECTOR PJ-H3000F (Mitsutoyo Co., Ltd.) to thereby calculate the shrinkage factor.

Adhesive Force

A tape piece of the adhesive sheet was pressured by a single reciprocal motion of a 2 kg roller on the top surface of a Si wafer and then left for 30 minutes. Thereafter, the 180° peeling adhesion (N/20 mm) of the Si wafer under normal conditions was measured. The peeling speed was (300 mm/min).

### 40° C. Heat-Sensitive Adhesive Force on Si Wafer and PI-Coated Wafer

A tape piece of the adhesive sheet was pressured by a single reciprocal motion of a 2 kg roller on the top surface of a Si wafer and PI-coated wafer and then left for 30 minutes at 40° C. Thereafter, the 180° peeling adhesion (N/20 mm) of the Si wafer and PI-coated wafer at a 40° C. heat-sensitive temperature was measured. The peeling speed was (300 mm/min).

Wafer Warping after Grinding

A back grinder DFG-8560 manufactured by Disco Co., Ltd. was used to grind the Si wafer to a thickness 50 μm. One minute after grinding, the Si wafer was adhered to the adhesive sheet and placed in a flat position to thereby measure the distance (mm) between the end of the wafer and the bottom surface.

TTV After Grinding

A back grinder DFG-8560 manufactured by Disco Co., Ltd. was used to grind the Si wafer to a thickness 50 μm, the Si wafer was adhered to the adhesive sheet and placed in a flat position. TTV (μm) between the upper and lower limiting values of the thickness of the inner surface of the Si wafer was measured using a HAMAMATSU MAPPING STAGE C8126 (Hamamatsu Photonics K. K.).

Measurement of Three-Point Bend Indentation Stress

An adhesive sheet was attached to a rigid plate using the lower surface as the base film to thereby measure the stress (g/cm) when indented to 30 μm using RSAIII manufactured by TA Instruments.

Evaluation of Grinding Stress Dispersal

A wafer piece of dimensions 2 mm×2 mm and a thickness of 15 μm was placed on the top surface of a wafer to be ground and a tape was adhered from above. The dimple depth and wafer cracking when grinding the wafer back surface were evaluated.

Chipping and Cracking of Wafer after Grinding

The number of chipped or cracked wafers of 10 Si wafers having an adhesive tape attached that were ground to a thickness of 50 μm was confirmed.

Re-peel Characteristics of the Adhesive Sheet

An Si wafer with an attached adhesive tape and ground to a thickness of 50 μm was heated for one minute at 100° C. and then the adhesive sheet was re-peeled at 40° C. using an HR-8500II manufactured by Nitto Seiki Co., Ltd. The number of wafers for which peeling was enabled of the Si wafers with an attached adhesive tape was confirmed.

Wafer Organic Contamination

A tape piece of adhesive sheet was attached to an aluminum vapor deposition wafer and was left to stand for one day at 40° C. Then the tape piece of adhesive sheet was re-peeled and the amount of organic material transferred onto the wafer was measured using an ESCA (tradename “model 15400”: Ulvac Phi Inc.). A wafer to which an adhesive sheet was not at all attached was analyzed in the same manner and the transfer amount (atomic %) of organic material was evaluated by the increase in detected carbon atoms.

TABLE 1

| | Example | | | Comparative Example | | |
|---|---|---|---|---|---|---|
| | 1 | 2 | 3 | 1 | 2 | 3 |
| Base Film | PET | PI | PEN | PET | EVA | ET |
| Modulus of Elasticity of Adhesive | 3000 | 3400 | 6000 | 3000 | 70 | 3000 |
| Sheet (MPa) | | | | | | |
| Thickness of Adhesive Sheet (μm) | 50 | 50 | 50 | 20 | 40 | 35 |
| Heating Shrinkage Factor of | 0.2 | 0.05 | 0.1 | 0.2 | 1.8 | 0.2 |
| Adhesive Sheet (%) | | | | | | |
| Si Adhesive Force (N/20 mm) | 0.6 | 0.5 | 0.5 | 0.5 | 0.5 | 7.0 |
| 40° C. Heat-Sensitive Si Adhesive | 0.3 | 0.3 | 0.3 | 0.2 | 0.3 | 4.3 |
| Force (N/20 mm) | | | | | | |
| 40° C. Heat-Sensitive PI Adhesive | 0.3 | 0.3 | 0.3 | 0.2 | 0.4 | 4.5 |
| Force (N/20 mm) | | | | | | |
| Wafer Warping after grinding | 5 | 4 | 6 | 5 | 25 | 7 |
| (mm) | | | | | | |
| TTV After grinding (μm) | 3.8 | 3.5 | 3.5 | 3.5 | 6.5 | 3.6 |
| Three-Point Bend Indentation | 140 | 145 | 135 | 260 | 145 | 250 |
| Stress (g/m) | | | | | | |
| Dimple Depth (μm) | 8 | 8 | 7 | 12 | 8 | 12 |
| | | | | (crack) | | (crack) |
| Chipping and Cracking of Wafer | 10 | 10 | 10 | 2 | 10 | 6 |
| (No. of wafers) | | | | | | |
| Re-peel Characteristics | 10 | 10 | 10 | 10 | Base | 3 |
| (No. of wafers) | | | | | Film | |
| | | | | | melted | |
| Transfer Amount of Organic | 12.7 | 12.7 | 12.7 | 12.0 | 12.5 | 14.05 |
| Material (atomic %) | | | | | | |

As seen from Table 1, in the adhesive sheet in Examples 1 to 3, since a small maximum point stress measured by three point bending resulted from indenting to 30 μm, even when the wafer pieces were sandwiched, the dimple depth was 10 μm or less, and therefore in contrast to the problems caused in a rigid base film, stress dispersion characteristics were improved thereby enabling grinding of the edge without chipping. Furthermore the thickness deviation of the base film was small due to use of a superior rigid base film with an accurate thickness and therefore the wafer TTV after grinding was an extremely low value of 4 μm or less. Furthermore no melting of the base film was observed even after heating to 100° C., an increase in the adhesive force was not observed, and stable re-peel was possible. Consequently the organic contamination of the wafer was low.

The re-peelable adhesive sheet of the present invention is useful not only in the polishing of semiconductor wafers and the like, but also for protecting wafers and the like in various steps of working the wafers, for masking, or as a surface protective sheet that needs to be re-peelable, such as for tacking, fixing, etc.

This application claims priority to Japanese Patent Application No. 2009-244032. The entire disclosure of Japanese Patent Application No. 2009-244032 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A re-peelable adhesive sheet for grinding a semiconductor wafer comprising:
a base film, and
an adhesive layer laminated on the base film,
the re-peelable adhesive sheet has a modulus of elasticity of at least 10³ MPa, and a heating shrinkage factor of 1% or less after heating to 60° C. for 10 minutes, and
the adhesive layer has a thickness at which the maximum point stress is 200 g/cm or less, at a pressing amount of 30 μm from the adhesive layer side in a three-point bend test of the re-peelable adhesive sheet.

2. The re-peelable adhesive sheet of claim 1, wherein
the adhesive layer has a predetermined molecular weight components having an average molecular weight of 10⁵ or less of 10 wt% or less relative to the total polymer configuring an adhesive, and
a transfer amount of organic substances is less than or equal to 14.05 atomic% when the adhesive sheet is attached to an aluminum vapor deposition wafer, left for one day at 40° C., and then re-peeled, on the wafer.

3. The re-peelable adhesive sheet of claim 1, wherein
the adhesive layer include an acrylic polymer, and
the adhesive sheet had an adhesive force of 1.0 N/ 20 mm or less at 40° C. relative on a Si wafer or a polyimide coated wafer.

4. The re-peelable adhesive sheet of claim 1, wherein
the adhesive layer includes an acrylic polymer is obtained by copolymerizing 90 wt% or more of butyl acrylate with 5 wt% or less of acrylic acid monomer.

5. The re-peelable adhesive sheet of claim 1, wherein the adhesive layer has a thickness of at least 40 μm.
